(19) United States
(12) Patent Application Publication
(10) Pub. No.: US 2013/0252068 A1
(43) Pub. Date: Sep. 26, 2013

(54) MANUFACTURING METHOD OF HIGH-PERFORMANCE SILICON BASED ELECTRODE USING POLYMER PATTERN ON CURRENT COLLECTOR AND MANUFACTURING METHOD OF NEGATIVE ELECTRODE OF RECHARGEABLE LITHIUM BATTERY INCLUDING SAME

(71) Applicants: Joong Kee LEE, Seoul (KR); Won Chang CHOI, Gyeonggi-do (KR); Joo Man WOO, Seoul (KR); Ho Suk CHOI, Daejeon (KR); Jung Sub KIM, Gyeongsangnam-do (KR); Hieu Si NGUYEN, Seoul (KR); Chairul HUDAYA, Seoul (KR); A Young KIM, Daejeon (KR); Ji Hun PARK, Seoul (KR); Sang Ok KIM, Seoul (KR); Xuyan LIU, Seoul (KR)

(72) Inventors: Joong Kee LEE, Seoul (KR); Won Chang CHOI, Gyeonggi-do (KR); Joo Man WOO, Seoul (KR); Ho Suk CHOI, Daejeon (KR); Jung Sub KIM, Gyeongsangnam-do (KR); Hieu Si NGUYEN, Seoul (KR); Chairul HUDAYA, Seoul (KR); A Young KIM, Daejeon (KR); Ji Hun PARK, Seoul (KR); Sang Ok KIM, Seoul (KR); Xuyan LIU, Seoul (KR)

(73) Assignee: KOREA INSTITUTE OF SCIENCE AND TECHNOLOGY, Seoul (KR)

(21) Appl. No.: 13/593,985

(22) Filed: Aug. 24, 2012

(30) Foreign Application Priority Data
Mar. 20, 2012 (KR) 10-2012-0028406

(51) Int. Cl. H01M 4/64; H01M 4/04; H01M 4/66

(52) U.S. Cl. 429/149; 429/211; 427/58; 427/123

(57) ABSTRACT

Disclosed are a silicon nanostructured material with theoretical storage capacity of energy resulting from electrochemical reaction with lithium improved more than 10 times as compared to the existing graphite material and having superior output characteristics, an electrode including the same, and a secondary battery and an electrochemical capacitor including the electrode as a negative electrode. The physical stability of the electrode active material is improved and an electrode with high performance can be obtained. Since more energy can be stored as compared to the graphite material of the same thickness and high-output performance can be achieved through the nanostructure, energy density can be remarkably improved as compared to the existing lithium-ion battery by about 2 times. An asymmetric lithium-ion secondary battery including the electrode active material is applicable to storage of renewable energy, ubiquitous power source, power supply for machinery and vehicles, or the like.

### CROSS-REFERENCE TO RELATED APPLICATIONS

This application claims priority under 35 U.S.C. §119 to Korean Patent Application No. 10-2012-0028406, filed on Mar. 20, 2012, in the Korean Intellectual Property Office, the disclosure of which is incorporated herein by reference in its entirety.

### BACKGROUND

(a) Technical Field

The present invention relates to manufacturing of a high-performance electrode material whereby shape control of an electrode active material on electrode surface is possible and a lithium secondary battery (or lithium-ion capacitor). In particular, it relates to a method for manufacturing an electrode of a lithium secondary battery capable of maintaining high voltage of an electrode cell by using a micropatterned electrode active material allowing reversible reactions between lithium ion and the active material for a long time and exhibiting high capacity of about 2 times per unit volume and a novel hybrid lithium-ion battery including the same.

(b) Background Art

The lithium secondary battery has evolved consistently since one using lithium cobalt oxide and graphite respectively as positive electrode and negative electrode active materials of the secondary battery was commercialized in early 1990. At present, the composition of the electrode active materials is optimized to some extent. Although the silicon active material has about 10 times greater capacity than the graphite which is used for the negative electrode of the lithium secondary battery, the electrode active material may be delaminated from the current collector during repeated volume expansion (˜4 times) and contraction accompanying the reaction between the silicon active material and the lithium ion. This causes rapid decline of capacity and renders long-term use impractical.

Recently, use of an electrode in the form of a patterned silicon nanotube was presented to minimize the shear stress applied to the electrode active material owing to the volume expansion of the secondary battery. Although this resulted in improvement of electrode life to some extent, there was limitation in term of manufacturing cost or large-scale production.

In general, photolithography is employed for micropatterning [A lithographic apparatus, a method of controlling the apparatus and a device manufacturing method, Korean Patent Publication No. 2011-0112637, Dec. 14, 2011]. However, since this method is costly and spends large amount of energy and materials, non-photolithographic techniques such as microcontact printing (μCP) [Microcontact printing device using polymer stamp, Korean Patent Publication No. 2008-0097807, Nov. 6, 2008], inkjet printing [Manufacturing method of electronic device using inkjet printing, Korean Patent Publication No. 2011-0052953, May 19, 2011] and screen printing [Ink composition for screen printing and method of manufacturing pattern using the same, Korean Patent Publication No. 2011-0057309, Jun. 1, 2011] are used for micropatterning. However, inkjet printing or screen printing is not suitable for manufacturing of micropatterns of 10 μm or smaller in size. Microcontact printing (μCP) is a technique allowing direct formation of micropatterns of 10 μm or smaller without etching with minimum consumption of materials. The microcontact printing technique is mainly applied for patterning of self-assembled monolayers (SAMs). Recently, a new printing method of direct laser structuring on an electrode active material was developed [Method for treating laser-structured plastic surfaces, Korean Patent Publication No. 2006-0046625, May 17, 2006]. However, even these methods are limited a lot in direct patterning on the current collector for a secondary battery such as copper foil because of difficulty in large area processing, adhesion between the current collector and the electrode active material or heat produced during the process.

The existing techniques to suppress volume change resulting from electrochemical reactions with regard to electrochemical lithium-ion capacitor materials include use of activated carbon for the positive electrode and lithium-predoped graphite and carbide for the negative electrode [J. of Power Sources, 177(2008) 643-651] and use of a silicon or carbon composite with an oxygen content of about 20-30% for the negative electrode [JP-P-2010-117188; JP-P-2010-0869222010; JP-P-2008-253251]. However, they cannot solve the problem fundamentally because decrease of capacity is accompanied.

### SUMMARY

The inventors of the present invention have developed a high-performance electrode with minimized ohmic resistance by forming a polymer pattern on the surface of a metal foil as a current collector, forming patterned metallic seeds on the current collector by electroplating, forming a patterned electrode active material on the electrode active material via vapor deposition according to the shape of the surface (contour coating), and modifying the surface of the electrode.

Accordingly, the present invention is directed to providing a method for manufacturing a micropolymer-patterned current collector.

The present invention is also directed to providing a method for manufacturing an electrode material for an asymmetric hybrid lithium-ion battery or lithium-ion capacitor comprising an electrolyte solution of a lithium salt in an organic solvent using the micro-patterned dome type silicon electrode.

The present invention is also directed to providing an asymmetric lithium-ion secondary battery comprising the electrode material.

In one aspect, the present invention provides a method for manufacturing a micropolymer-patterned current collector, comprising:

(1) preparing a solution in which a polymer resin is dissolved in a solvent;

(2) coating the polymer solution on a current collector and drying the same;

(3) preparing a mixture solvent by diluting a solvent in step (1) with a nonsolvent; and

(4) treating a substrate on which the polymer solution is coated with the mixture solvent and drying the same.

In another aspect, the present invention provides a method for manufacturing a negative electrode for a lithium secondary battery, comprising:

(i) performing electroless copper plating on a micropolymer pattern formed on a micropolymer-patterned current collector;

(ii) removing the polymer pattern and forming an electrode active material on the current collector by chemical deposition or physical deposition; and

(iii) modifying the surface of the electrode active material.

In another aspect, the present invention provides a single-cell battery comprising one lithiated negative electrode and one positive electrode comprising activated carbon.

In another aspect, the present invention provides a multiple-cell battery comprising 2-10 lithiated negative electrodes and 2-10 positive electrodes comprising activated carbon stacked alternatingly.

Other features and aspects of the present invention will be apparent from the following detailed description, drawings and claims.

### BRIEF DESCRIPTION OF THE DRAWINGS

The above and other objects, features and advantages of the present invention will now be described in detail with reference to certain exemplary embodiments thereof illustrated in the accompanying drawings which are given hereinbelow by way of illustration only, and thus are not limitative of the invention, and wherein:

FIG. 1 shows the surface of a copper current collector (a) and that after copper plating in Example 1-(1) (b);

FIG. 2 shows a polymer template formed in Example 1-(2) (a) and a latticed surface formed in Example 1-(2) (b);

FIG. 3 shows phosphorus-doped silicon deposited on a copper plating-controlled current collector (a) and phosphorus-doped silicon deposited on a latticed current collector (b);

FIG. 4 schematically shows a single-cell battery of the present invention;

FIG. 5 shows a multiple-cell battery comprising 4 electrodes (a), connection of lithated electrodes (b) and configuration of a lithated, phosphorus-doped silicon//activated carbon electrode quadruple-cell battery (c);

FIG. 6 shows discharge capacity (mAh/cm²) of a silicon electrode using a copper current collector (square), a silicon electrode using a copper-plated current collector (circle) and a silicon electrode using a copper-plated current collector after polymer patterning (triangle) with discharge cycles;

FIG. 7 shows discharge capacity (mAh/cm²) of a lithated silicon electrode using a copper-plated current collector after polymer patterning (black) and a lithated graphite electrode using a copper current collector (red) with discharge cycles;

FIG. 8 shows energy density of a lithated graphite electrode (red) and a lithated silicon electrode (green); and

FIG. 9 shows discharge capacity (mAh/cm²) of a single-cell silicon capacitor (black) and a multiple-cell silicon capacitor (red) with discharge cycles.

### DETAILED DESCRIPTION

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The inventors of the present invention have developed a high-performance electrode with minimized ohmic resistance by forming a polymer pattern on the surface of a metal foil as a current collector, forming patterned metallic seeds on the current collector by electroplating, forming a patterned electrode active material on the electrode active material via vapor deposition according to the shape of the surface (contour coating), and modifying the surface of the electrode.

Copper foil is frequently used as the current collector of a negative electrode for a secondary battery because of high tensile strength and conductivity. Since delamination of the electrode active material from the current collector leads to deteriorated performance of the battery, it is necessary to maximize the interfacial area between the electrode active material and the current collector. In the present invention, a method of directly plating copper on a current collector and a method of forming a polymer template were compared in effect.

In one aspect, the present invention provides a method for manufacturing a micropolymer-patterned current collector, comprising:

(1) preparing a solution in which a polymer resin is dissolved in a solvent;

(2) coating the polymer solution on a current collector and drying the same;

(3) preparing a mixture solvent by diluting the solvent in step (1) with a nonsolvent; and

(4) treating a substrate on which the polymer solution is coated with the mixture solvent and drying the same.

In an exemplary embodiment of the present invention, in the step (1), the polymer resin is one or more selected from a group consisting of polyethylene, polystyrene, polypropylene, polyethylene and poly(methyl methacrylate).

In an exemplary embodiment of the present invention, in the step (1), the solvent is one or more selected from a group consisting of acetone, acetic acid, aniline, allylamine, benzene, bromobenzene, chloroform, chloroethane, chlorobenzene, chlorohexanol, ethylbenzene, ethoxyethane and hexane.

In an exemplary embodiment of the present invention, in the step (1), the polymer resin is included in the polymer solution in an amount of 0.01-50 wt %.

In an exemplary embodiment of the present invention, in the step (2), the coating is doctor blade coating, bar coating, dip coating or spin coating, but is not necessarily limited thereto.

In an exemplary embodiment of the present invention, in the step (2), the drying is performed at 0-100° C. for 1-24 hours.

In an exemplary embodiment of the present invention, in the step (3), the nonsolvent is one or more selected from a group consisting of butanol, 1-butoxybutane, 1,3-butanediol, cyclohexanol, ethanol, ethylene glycol, formamide, 1-pentanol, 2-isopropoxypropane, isopropyl alcohol, methanol and water, but is not necessarily limited thereto.

In an exemplary embodiment of the present invention, in the step (3), the mixture solvent is prepared by diluting the solvent which is acetone, acetic acid, aniline, allylamine, benzene, bromobenzene, chloroform, chloroethane, chlorobenzene, chlorohexanol, ethylbenzene, ethoxyethane or hexane with the nonsolvent which is butanol, 1-butoxybutane, 1,3-butanediol, cyclohexanol, ethanol, ethylene glycol, formamide, 1-pentanol, 2-isopropoxypropane, isopropyl alcohol, methanol or water to 1-100 vol %.

In an exemplary embodiment of the present invention, in the step (4), the drying is performed at 0-100° C. for 1-24 hours. More specifically, the drying is performed at 70-90° C. for 1-5 hours.

In another aspect, the present invention provides a method for manufacturing a negative electrode for a lithium secondary battery, comprising:

(i) performing electroless copper plating on a micropolymer pattern formed on a micropolymer-patterned current collector;

(ii) removing the polymer pattern and forming an electrode active material on the current collector by chemical deposition or physical deposition; and

(iii) modifying the surface of the electrode active material.

According to a method of controlling the surface of the copper current collector using a polymer template, the polymer resin poly(methyl methacrylate) (PMMA) is dissolved in a chloroform solvent to about 3 wt % and coated on the Cu current collector to about 100 μm using a doctor blade.

When the Cu current collector is immersed in a chloroform-methanol mixture solvent for several seconds and taken out, lattices of the polymer resin are formed on the Cu current collector. Then, Cu electroplating is conducted to lattice the Cu current collector having the polymer resin latticed on the surface.

In an exemplary embodiment of the present invention, in the step (i), the plating is performed at 20-30° C. for 10-30 seconds under a current density of current density of 10-20 A/cm² using a mixture of 60 g/L CuSO₄H₂O, 150 g/L H₂S0₄ and 50 ppm HCl.

More specifically, silicon is used for the negative electrode of the secondary battery and a surface-controlled copper current collector manufactured in Example 1 (1) and (2) is used as the current collector. A silicon thin-film negative electrode is prepared directly on the copper current collector by electron cyclotron resonance chemical vapor deposition.

The surface-controlled copper current collector is cut and dried at 80° C. for 1 hour after removing the organic matter present on the surface by cleansing with acetone or ethanol.

The dried surface-controlled copper current collector is put in a chamber of a deposition apparatus and the substrate temperature is adjusted to 200° C. while maintaining a high-vacuum state of 1×10⁻⁵ Torr or lower. After flowing 30 sccm of argon gas into the chamber, plasma is generated with 700 W of microwave power while maintaining pressure at 15 mTorr. A phosphorus-doped silicon thin-film electrode is prepared by injecting 5 sccm of silane (SiH₄) gas and 0.2 sccm of phosphine (PH₃) while controlling the reflected power within 5 W.

In an exemplary embodiment of the present invention, in the step (ii), the micropolymer pattern is removed by immersing the current collector in a solvent.

In an exemplary embodiment of the present invention, the solvent is chloroform.

In an exemplary embodiment of the present invention, in the step (ii), the electrode active material is a phosphorus-doped silicon thick film comprising silane and phosphine.

In an exemplary embodiment of the present invention, in the step (iii), the surface modification comprises connecting a copper plate to a positive electrode and an electrode to a negative electrode in a plating solution and flowing electrical current or placing the electrode active material in a vacuum chamber and coating copper on the electrode active material under vacuum to a thickness of 0.1-20 nm.

In another aspect, the present invention provides a battery comprising a negative electrode prepared by the method for manufacturing a negative electrode for a lithium secondary battery of the present invention and activated carbon as a positive electrode.

In an exemplary embodiment of the present invention, the battery is a single-cell battery comprising one negative electrode and one positive electrode comprising activated carbon.

In another exemplary embodiment of the present invention, the battery is a multiple-cell battery comprising multiple negative electrodes and multiple positive electrodes comprising activated carbon stacked alternatingly.

### EXAMPLES

The present invention will be described in more detail through examples. The following examples are for illustrative purposes only and it will be apparent to those skilled in the art not that the scope of this invention is not limited by the examples.

### Example 1

### Comparison of Method for Surface Control of Current Collector

(1) Direct Copper Plating on Current Collector of Secondary Battery

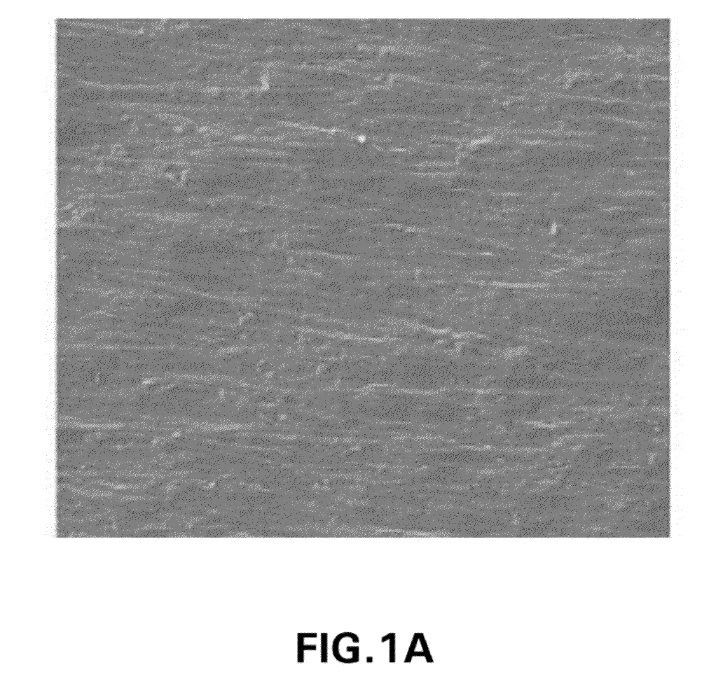

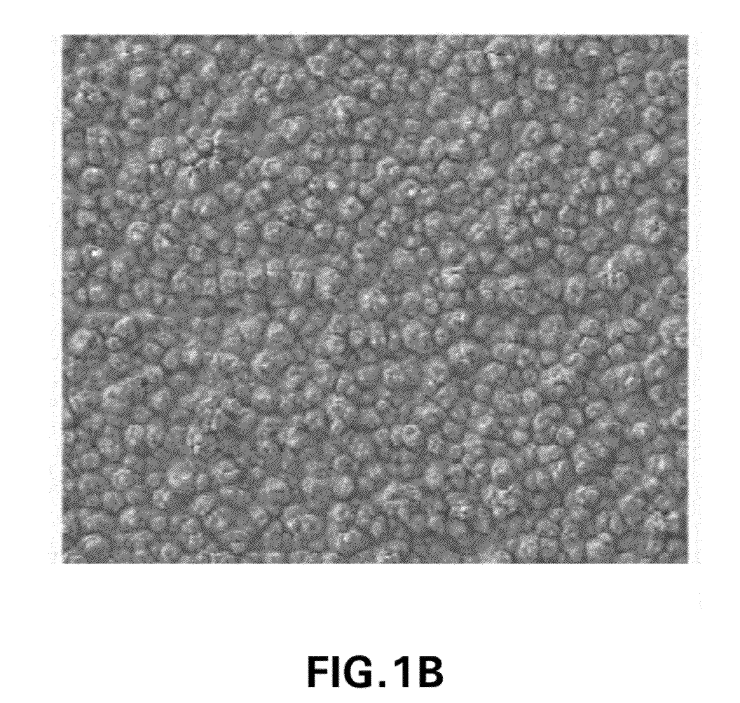

One side of a Cu foil as a copper current collector (thickness=˜20 μm) was surface-controlled by electroplating as follows. The (−) electrode of a copper current collector to be treated was connected to a copper solution comprising 60 g/L CuSO₄.H₂O, 150 g/L H₂S0₄ and 50 ppm HCl and the (+) electrode was connected to a highly pure copper plate. Then, a surface-controlled electroplated copper film was prepared by electroplating for 10, 15 or 20 sec at a current density of 10 mA/cm² using a DC rectifier. FIG. 1 shows the surface change of the copper current collector upon direct copper plating.

(2) Copper Plating After Formation of Polymer Template on Current Collector

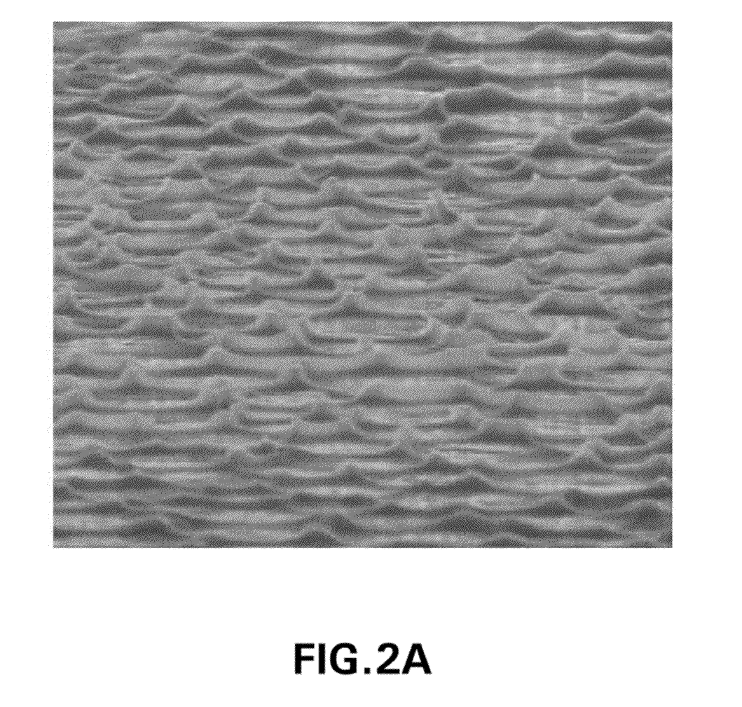

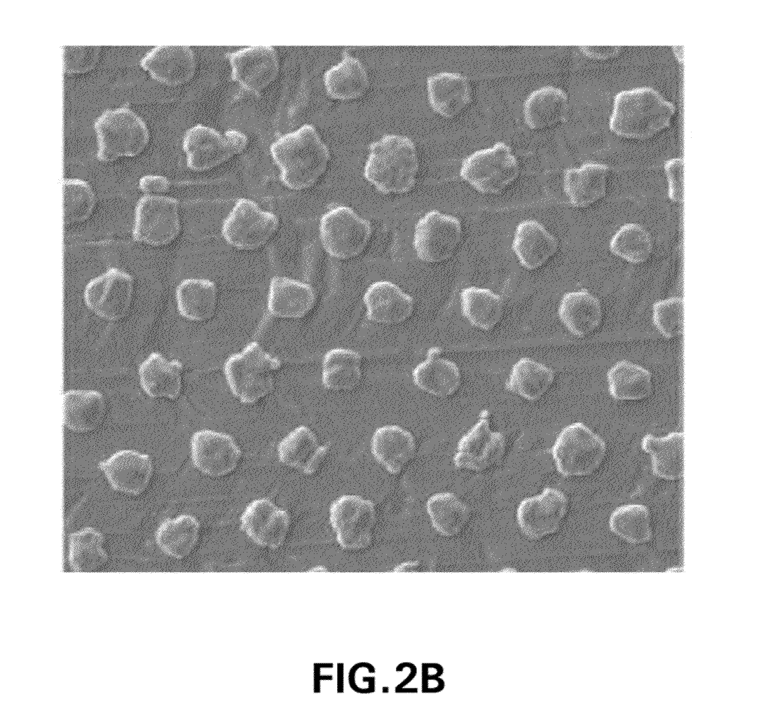

Surface control of the copper current collector using a polymer template was performed as follows. The polymer resin poly(methyl methacrylate) (PMMA) was dissolved in a chloroform solvent to about 3 wt % and coated on a Cu current collector to about 100 μm using a doctor blade. When the Cu current collector was immersed in a chloroform-methanol mixture solvent for several seconds and then taken out, lattices of the polymer resin were formed on the Cu current collector. Then, Cu electroplating was conducted to lattice the Cu current collector having the polymer resin latticed on the surface. The Cu electroplating was performed as follows. The (−) electrode of the polymer resin-latticed copper current collector was connected to a copper solution comprising 60 g/L CuSO₄.H₂O, 150 g/L H₂S0₄ and 50 ppm HCl and the (+) electrode was connected to a highly pure copper plate. Then, a latticed Cu pattern was prepared by electroplating for 10, 15 or 20 sec at a current density of 10 mA/cm² using a DC rectifier. To remove the polymer resin lattice remaining on the surface, the Cu current collector was immersed in a chloroform solvent for about 10 seconds. FIG. 2 shows a polymer template formed on the copper foil which is the current collector and the copper lattices arranged regularly on the current collector after copper plating and removal of the polymer template.

### Example 2

### Manufacturing of Silicon Negative Electrode on Shape-Controlled Surface

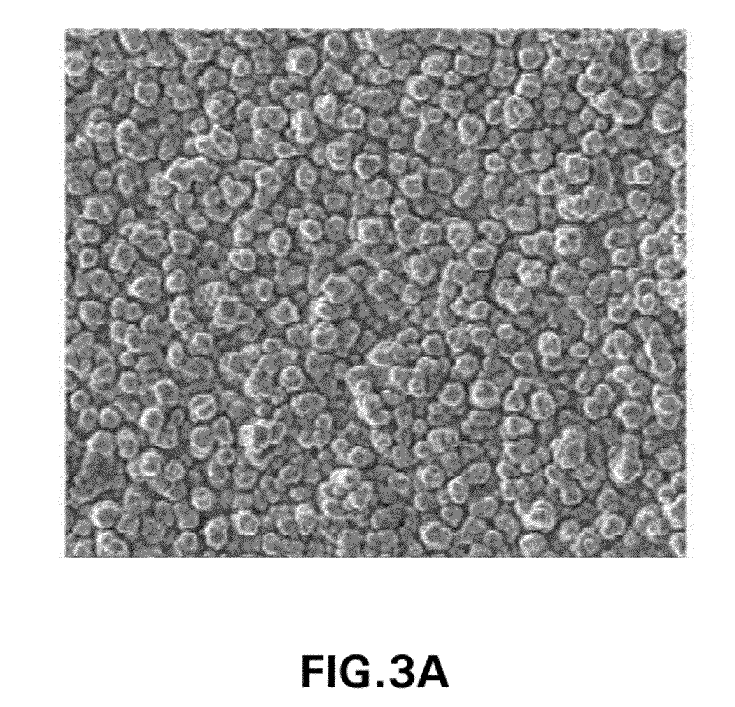

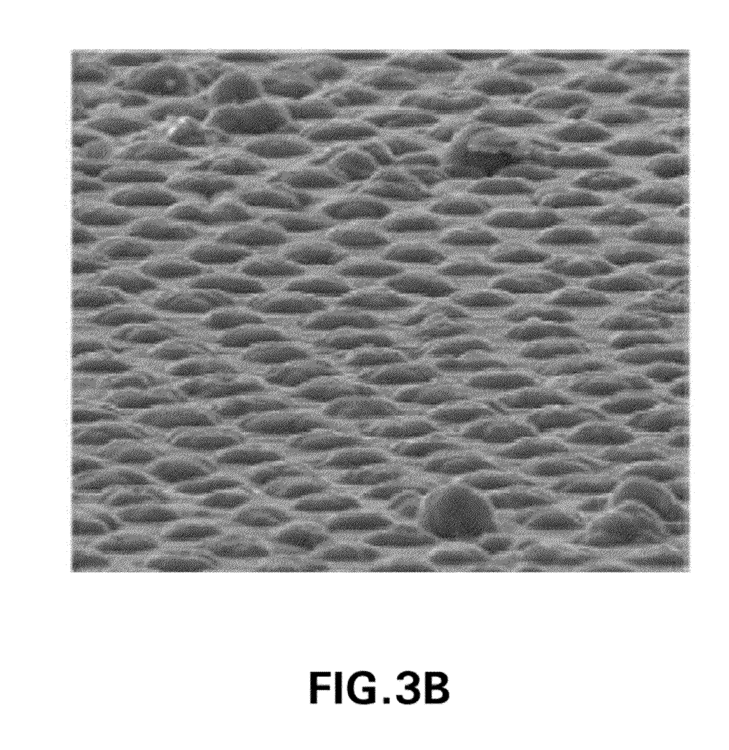

Silicon was used as a negative electrode of a secondary battery and the surface-controlled copper current collector prepared in Example 1 (1) and (2) was used as a current collector. Also, porous copper was used as a copper current collector to manufacture a multiple-cell battery. A silicon thin-film negative electrode was prepared directly on the current collector by electron cyclotron resonance chemical vapor deposition. First, the surface-controlled copper current collector was cut to a size of 10×10 cm² and dried at 80° C. for 1 hour after removing the organic matter present on the surface by cleansing with acetone or ethanol. The dried surface-controlled copper current collector was put in a chamber of a deposition apparatus and the substrate temperature was adjusted to 200° C. while maintaining a high-vacuum state of 1×10⁻⁵ Torr or lower. After flowing 30 sccm of argon gas into the chamber, plasma was generated with 700 W of microwave power while maintaining pressure at 15 mTorr. A phosphorus-doped silicon thin-film electrode was prepared by injecting 5 sccm of silane (SiH₄) gas and 0.2 sccm of phosphine (PH₃) while controlling the reflected power within 5 W. The thickness of the prepared silicon thin film was 1.5 μm and the phosphorus content in the silicon thin film was about 1% based on weight. As seen from FIG. 3, whereas the silicon prepared on the current collector of Example 1-(1) was irregularly spherical with size of 2-5 μm, the silicon prepared on the current collector of Example 1-(2) was conical in shape and the diameter and height of each lattice was about 3-4 μm and 1-1.5 μm, respectively.

### Example 3

### Manufacturing of Single-Cell Battery Comprising Lithated Silicon and Activated Carbon

As a positive electrode material, 85 wt % of activated carbon (YP-50F, Kuraray), 5 wt % of DB-100 and 10 wt % of PVdF were mixed in a homogenizer at 5000 rpm for 15 minutes. The mixed slurry was cast on aluminum foil (20 μm, Sam-A Aluminum) or aluminum mesh using a 80-100 μm cast slurry and dried in an oven at 80° C. for at least 2 hours. The dried foil was cut to a size of 2×2 cm² and pressed to a thickness of 40-50 μm using a hot roller press at 110-120° C. and was used as the positive electrode.

As a negative electrode, the phosphorus-doped silicon thin-film negative electrode prepared in Example 2 was used after cutting to a size of 2×2 cm². The electrode was surface-treated to improve electrical conductivity. The surface treatment was conducted using the Q150T S sputter of Quorum Technologies (UK) and copper target at 10⁻² Torr with a sputter current of 60 mA. The electrode was rotated for uniform surface treatment. The thickness of the resulting copper film is 2.5-7.5 nm depending on the processing condition. A lithated silicon electrode was prepared by connecting the positive (+) electrode to a Li electrode and the negative (−) electrode to a silicon electrode and intercalating lithium into the silicon electrode from 3 V to 0.001 V under constant current of 0.1 C. When intercalation into the silicon electrode was completed, the lithated silicon electrode was used as the negative electrode.

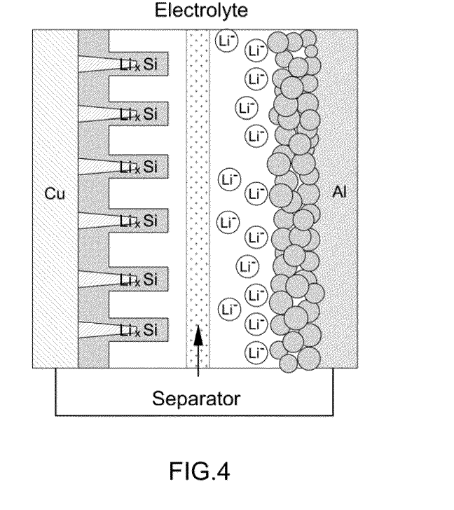

A pouch battery was manufactured using 1 M LiPF₆ EC/EMC/DMC (1:1:1 v/v/v) as electrolyte and polypropylene (PP) as separator. FIG. 4 schematically shows the resulting single-cell battery.

### Example 4

### Manufacturing of Multiple-Cell Battery Comprising Lithated Silicon Formed on Porous Copper Current Collector and Activated Carbon

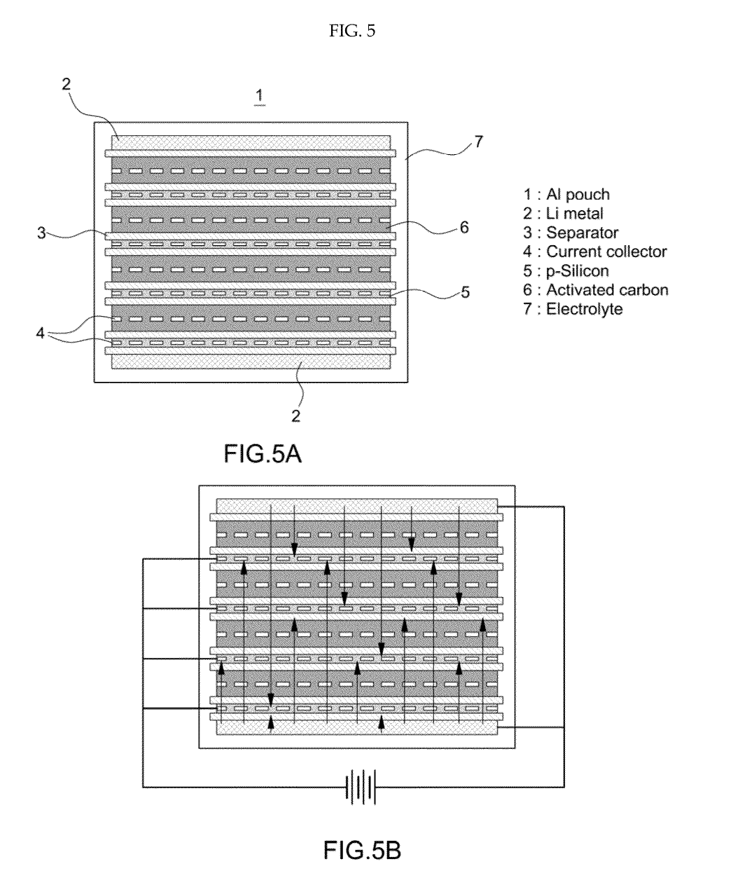

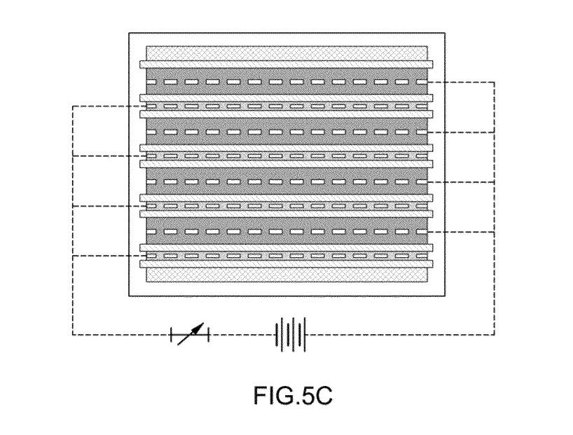

The phosphorus-doped silicon thin-film negative electrode formed on the porous copper current collector in Example 2 was cut to a size of 2×2 cm² for use as a negative electrode and an active carbon electrode in Example 2 was used as a positive electrode. A multiple-cell battery was manufactured using 4 sheets of the negative electrode, 4 sheets of the positive electrode, 2 sheets of Li electrode and polypropylene (PP) as a separator, as shown in FIG. 5(a).

The electrodes were assembled in a dry room of relative humidity of 0.3% or lower using Al pouch. 1 M LiPF₆ EC/EMC/DMC (1:1:1 v/v/v) was used as electrolyte solution.

The positive (+) electrode was connected to the phosphorus-doped silicon thin film formed on the porous copper current collector and the negative (−) electrode was connected to the Li electrode. Then, lithium was intercalated into the phosphorus-doped silicon thin film deposited on the porous copper current collector from 3 V to 0.001 V under constant current of 0.1 C. When intercalation into the electrode was completed, the lithated silicon electrode was connected to the negative electrode and the positive electrode was connected to the activated carbon electrode, and electrochemical characteristics were measured. The result is shown in FIGS. 5(b) and (c).

### Comparative Example 1

### Electrochemical Performance of Single-Cell Battery Comprising Lithated Silicon and Activated Carbon

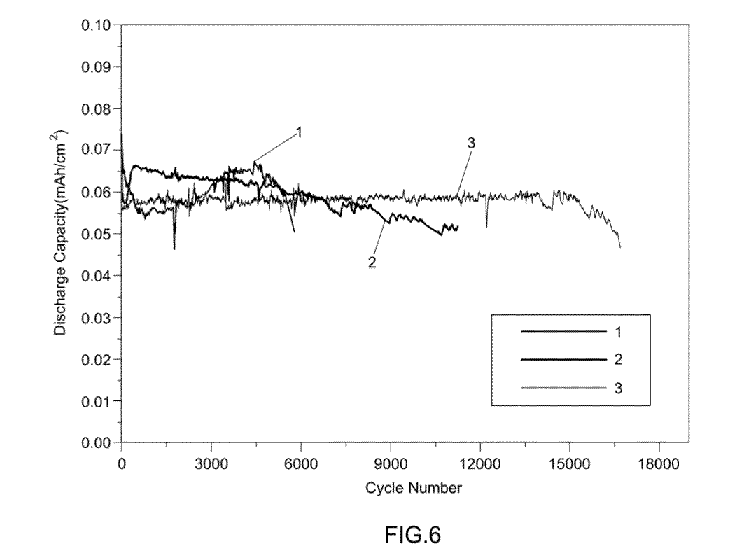

In order to test the electrochemical characteristics of the lattice-controlled phosphorus-doped silicon thin film formed on the Cu current collector prepared in Example 1 (1) and (2), a single-cell battery was manufactured as in Example 3 and electrochemical characteristics were tested. The electrochemical characteristics were evaluated by a charge-discharge test in the voltage range of 2.2-3.8 V using a battery cycler (WBCS3000, Won-A Tech.) under a constant current of 20 C. The result is shown in FIG. 6. The battery prepared by direct copper electroplating on the current collector in Example 1 (1) showed a life of about 12,000 cycles (2 in FIG. 6), and the surface-untreated electrode showed a life of about 6000 cycles (1 in FIG. 6). In contrast, the silicon electrode plated in the form of lattices using the polymer template in Example 1 (2) showed a superior life of about 18,000 cycles (3 in FIG. 6).

### Comparative Example 2

### Comparison of Electrochemical Performance with Battery Comprising Lithated Graphite and Activated Carbon

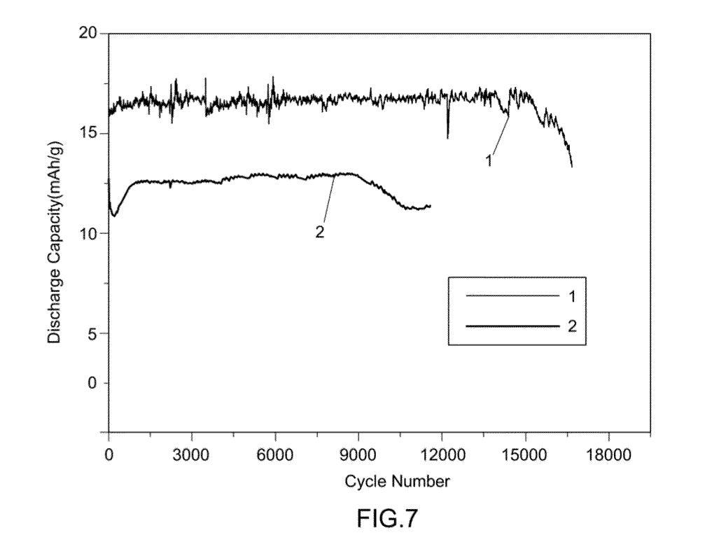

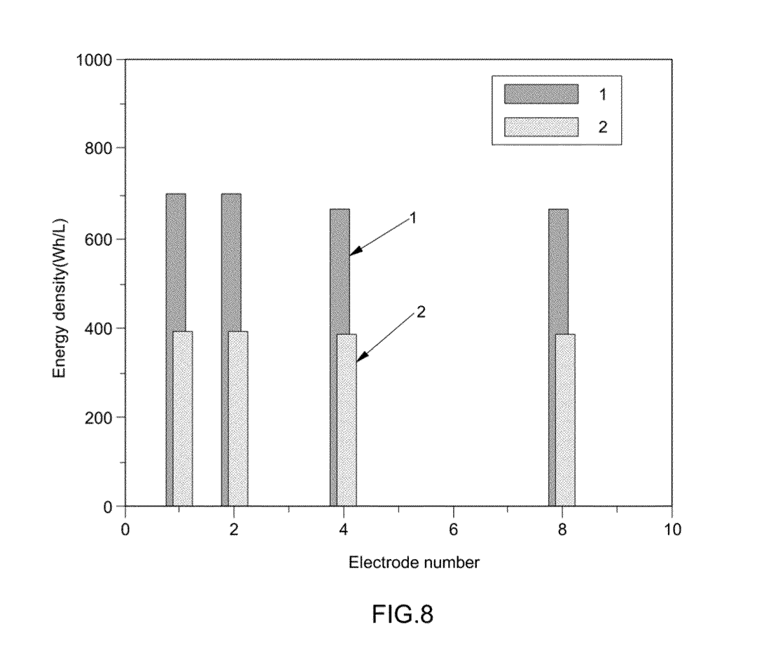

A single-cell battery was manufactured as follows to compare the performance of the lithated silicon negative electrode of Example 4 with that of a lithated graphite electrode commonly used in a lithium-ion capacitor. Graphite (SFG₆) as an active material, Denka Black-100 as a conductor and polyvinylidene fluoride (PVdF) as a binder were mixed at 90:5:5 based on weight and stirred uniformly in N-methylpyrrolidinone (NMP) at 5000 rpm. Thus prepared slurry was coated on cooper foil as a current collector and dried at 80° C. for 1 hour. The dried negative electrode was cut to a regular size (2×2 cm²) and pressed to a thickness of 60 μm at 120° C. using a roller press. Then, a single-cell battery was manufactured as in Example 3. As the current collector, the one prepared in Example 1 (2) was used since it exhibited superior electrochemical properties. The result is shown in FIG. 7. The battery using the lithated silicon electrode prepared according to the present invention (1 in FIG. 7) showed better performance and life than the battery using the lithated graphite electrode (2 in FIG. 7). The energy density was compared considering the thickness of the negative electrode (FIG. 8). It can be seen that the battery using the lithated silicon electrode prepared according to the present invention exhibits about 50% improved energy density (Wh/L). The electrode area was the same as 2×2 cm² and the test condition was the same as in Example 4.

### Comparative Example 3

### Comparison of Electrochemical Performance of Single-Cell Battery and Multiple-Cell Battery

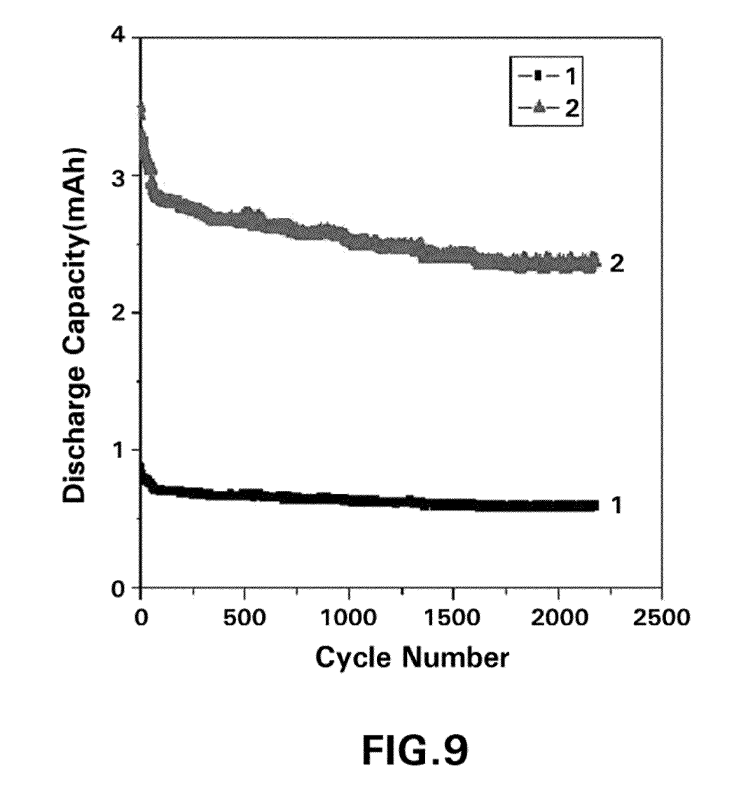

The electrochemical characteristics of the lithated silicon electrode/ activated carbon hybrid batteries manufactured in Examples 3 and 4 was evaluated. The electrochemical test was conducted under the same condition as described above. As seen from FIG. 9, the total capacity of the multiple-cell battery (2 in FIG. 9) increased in proportion to the number of the stacked cells times the capacity of the single-cell battery (1 in FIG. 9). Also, the decrease of initial efficiency increased proportionally.

The features and advantages of the present disclosure may be summarized as follows:

(i) The maximized contact area with silicon, which is the electrode active material, enhances physical adhesion and thus improves mechanical stability of the electrode active material.

(ii) The increased contact area between the electrolyte and the electrode active material and between the electrode active material and the current collector increases transport of lithium ions per unit time and thus improves electrode efficiency.

(iii) Since the lithated silicon material experiences less shear stress, the stress associated with volume change accompanying the reaction with lithium is reduced and thus the electrode stability is improved.

(iv) Since the lithated porous silicon electrode of the present invention has superior energy density per unit volume and exhibits very superior cycle performance even under high electrical current, a lithium-ion secondary battery comprising the same satisfies both high-capacity and high-output characteristics and may be used as power supply source of light and large-sized mobile devices.

What is claimed is:

1. A method for manufacturing a micropolymer-patterned current collector, comprising:
(a) preparing a solution in which a polymer resin is dissolved in a solvent;
(b) coating the polymer solution on a current collector and drying the same;
(c) preparing a mixture solvent by diluting the solvent in step (a) with a nonsolvent; and
(d) treating a substrate on which the polymer solution is coated with the mixture solvent and drying the same.

2. The method according to claim 1, wherein, in said preparing the polymer solution, the polymer resin is one or more selected from a group consisting of polyethylene, polystyrene, polypropylene, polyethylene and poly(methyl methacrylate).

3. The method according to claim 1, wherein, in said preparing the polymer solution, the solvent is one or more selected from a group consisting of acetone, acetic acid, aniline, allylamine, benzene, bromobenzene, chloroform, chloroethane, chlorobenzene, chlorohexanol, ethylbenzene, ethoxyethane and hexane.

4. The method according to claim 1, wherein, in said preparing the polymer solution, the polymer resin is included in the polymer solution in an amount of 0.01-50 wt %.

5. The method according to claim 1, wherein, in said preparing the polymer solution, the current collector is a porous copper current collector.

6. The method according to claim 1, wherein, in said coating the polymer solution, the coating is doctor blade coating, bar coating, dip coating or spin coating.

7. The method according to claim 1, wherein, in said drying the polymer solution, the drying is performed at 0-100° C. for 1-24 hours.

8. The method according to claim 1, wherein, in said preparing the mixture solvent, the nonsolvent is one or more selected from a group consisting of butanol, 1-butoxybutane, 1,3-butanediol, cyclohexanol, ethanol, ethylene glycol, formamide, 1-pentanol, 2-isopropoxypropane, isopropyl alcohol, methanol and water.

9. The method according to claim 1, wherein, in said preparing the mixture solvent, the mixture solvent is prepared by diluting the solvent which is acetone, acetic acid, aniline, allylamine, benzene, bromobenzene, chloroform, chloroethane, chlorobenzene, chlorohexanol, ethylbenzene, ethoxyethane or hexane with the nonsolvent which is butanol, 1-butoxybutane, 1,3-butanediol, cyclohexanol, ethanol, ethylene glycol, formamide, 1-pentanol, 2-isopropoxypropane, isopropyl alcohol, methanol or water to 1-100 vol %.

10. The method according to claim 1, wherein, in said drying the mixture solvent, the drying is performed at 0-100° C. for 1-24 hours.

11. A method for manufacturing a negative electrode for a lithium secondary battery, comprising:
performing electroless copper plating on a micropolymer pattern formed on a micropolymer-patterned current collector;
removing the polymer pattern and forming an electrode active material on the current collector by chemical deposition or physical deposition; and
modifying the surface of the electrode active material.

12. The method according to claim 11, wherein the current collector is a porous copper current collector.

13. The method according to claim 11, wherein, in said performing the electroless copper plating, the plating is performed at 20-30° C. for 10-30 seconds under a current density of current density of 10-20 A/cm² using a mixture of 60 g/L CuSO₄H₂O, 150 g/L H₂S0₄ and 50 ppm HCl.

14. The method according to claim 11, wherein, in said removing the polymer pattern, the micropolymer pattern is removed by immersing the current collector in a solvent.

15. The method according to claim 14, wherein the solvent is chloroform.

16. The method according to claim 11, wherein, in said forming the electrode active material, the electrode active material is a phosphorus-doped silicon thick film comprising silane and phosphine.

17. The method according to claim 11, wherein, in said modifying the surface of the electrode active material, the surface modification comprises connecting a copper plate to a positive electrode and an electrode to a negative electrode in a plating solution and flowing electrical current or placing the electrode active material in a vacuum chamber and coating copper on the electrode active material under vacuum to a thickness of 0.1-20 nm.

18. A single-cell battery comprising one lithiated negative electrode manufactured by the method according to any one of claims 10 to 15 and one positive electrode comprising activated carbon.

19. A multiple-cell battery comprising 2-10 lithiated negative electrodes manufactured by the method according to any one of claims 10 to 15 and 2-10 positive electrodes comprising activated carbon stacked alternatingly.
